(19) United States
(12) Patent Application Publication
(10) Pub. No.: US 2015/0026166 A1
(43) Pub. Date: Jan. 22, 2015

(54) APPARATUS FOR RECOMMENDING CONTENTS USING HIERARCHICAL CONTEXT MODEL AND METHOD THEREOF

(71) Applicant: GWANGJU INSTITUTE OF SCIENCE AND TECHNOLOGY, Gwangju (KR)

(72) Inventors: Jong Hyun HAN, Gwangju (KR); Woontack WOO, Daejeon (KR)

(21) Appl. No.: 14/338,004

(22) Filed: Jul. 22, 2014

(30) Foreign Application Priority Data
Jul. 22, 2013 (KR) 10-2013-0086314

(51) Int. Cl. G06F 17/30

(52) U.S. Cl. CPC G06F 17/30554
USPC 707/723

(57) ABSTRACT

According to an embodiment of the present invention, an apparatus for recommending contents using a hierarchical context model includes: an input unit configured to receive a keyword to be retrieved from a user according to an operation of a key or a menu; a sensing unit configured to acquire context information of the user when the keyword is received; a control unit configured to match tag information of contents and the context information of the user corresponding to the received keyword with preset hierarchical context models, respectively to extract contents relevant words and context relevant words based on the matched results and calculate contents similarity based on the extracted contents relevant words and context relevant words to rank at least one pre-collected contents based on the calculated contents similarity; and a display unit configured to display some or all of the at least one ranked contents on a screen.

### CROSS REFERENCE TO RELATED APPLICATION

This application claims the benefit of Korean Patent Application No. 10-2013-0086314, filed on Jul. 22, 2013, entitled “Apparatus For Recommending Contents Using Hierarchical Context Model And Method Thereof”, which is hereby incorporated by reference in its entirety into this application.

### BACKGROUND OF THE INVENTION

1. Technical Field

The present invention relates to a contents recommending technique, and more particularly, to an apparatus for recommending contents using a hierarchical context model capable of collecting tag information of contents and context information of a user corresponding to a keyword received from a user, matching the tag information of the collected contents and the context information of the user with a preset context model to extract contents relevant words and context relevant words based on the matched result, and ranking the contents based on similarity between the extracted contents relevant words and context relevant words, and a method thereof.

2. Description of the Related Art

A mobile device is one of the most public information devices and is evolved to a device which provides adaptive or personal services to a user. With the rapid development of hardware, more intelligent services for obtaining relevant information anytime, anywhere have been developed.

However, there is a need to consider suitability of contents under a given situation for a user which uses a device having a small screen or other devices such as a restrictive input device.

Therefore, so as to meet more requirements in an information search, a demand for a new technique handling a context and a behavior of the user is increasingly growing.

### SUMMARY OF THE INVENTION

The present invention has been made in an effort to provide an apparatus for recommending contents using a hierarchical context model capable of collecting tag information of contents and context information of a user corresponding to a keyword received from a user, matching the tag information of the collected contents and the context information of the user with a preset context model to extract contents relevant words and context relevant words based on the matched result, and ranking the contents based on similarity between the extracted contents relevant words and context relevant words, and a method thereof.

However, objects of the present invention are not limited the above-mentioned matters and other objects can be clearly understood to those skilled in the art from the following descriptions.

According to an exemplary embodiment of the present invention, there is provided an apparatus for recommending contents using a hierarchical context model, including: an input unit configured to receive a keyword to be retrieved from a user according to an operation of a key or a menu; a sensing unit configured to acquire context information of the user when the keyword is received; a control unit configured to match tag information of contents and the context information of the user corresponding to the received keyword with preset hierarchical context models, respectively to extract contents relevant words and context relevant words based on the matched results and calculate contents similarity based on the extracted contents relevant words and context relevant words to rank at least one pre-collected contents based on the calculated contents similarity; and a display unit configured to display some or all of the at least one ranked contents on a screen.

The control unit may confirm whether the acquired context information of the user is updated when the context information of the user is acquired, and map the acquired context information of the user to the hierarchical context model when the context information of the user is updated.

The control unit may confirm whether the acquired context information of the user is updated when the context information of the user is acquired and may not map the acquired context information of the user to the hierarchical context model when the context information of the user is not updated.

The contents similarity may be obtained by Equation

$$cntsim ( U , C ) = \frac{{Σ}_{tag ∈ C} {max}_{ctx ∈ U} ( sim ( tag , ctx ) )}{N ( C )} ,$$

in the above Equation, U represents a set of nodes relevant to the context of the user, C represents a set of nodes relevant to the context of the contents, ctx represents a member of U, tag represents a member of C, and sim (tag, ctx) represents similarity between tag and ctx.

The similarity may be obtained by Equation sim(x,y)=spec(LCS(x,y)) when tax=x and ctx=y, in the above Equation, LCS (x, y) represents a least common subsumer between node x and node y.

The control unit may match the tag information of the contents with the preset hierarchical context model to extract contents relevant words based on the matched result, and extract the contents relevant words from a node corresponding to the tag information of the contents and all upper nodes connected to the node within the hierarchical context model.

The control unit may match the context information of the user with the preset hierarchical context model to extract context relevant words based on the matched result and extract the context relevant words from a node corresponding to the context information of the user and all upper nodes connected to the node within the hierarchical context model.

The apparatus may further include: a storage unit configured to store the hierarchical context model for recommending the contents to be retrieved by the user.

According to another exemplary embodiment of the present invention, there is provided an apparatus for recommending contents using a hierarchical context model, including: an input unit configured to receive a keyword to be retrieved from a user according to an operation of a key or a menu; a control unit configured to match tag information of contents and the context information of the user corresponding to the received keyword with preset hierarchical context models, respectively to extract contents relevant words and context relevant words based on the matched results and calculate contents similarity based on the extracted contents relevant words and context relevant words to rank at least one pre-collected contents based on the calculated contents similarity; and a display unit configured to display some or all of the at least one ranked contents on a screen.

The control unit may confirm whether the acquired context information of the user is updated when the context information of the user is acquired, and map the acquired context information of the user to the hierarchical context model when the context information of the user is updated.

The control unit may confirm whether the acquired context information of the user is updated when the context information of the user is acquired and may not map the acquired context information of the user to the hierarchical context model when the context information of the user is not updated.

The contents similarity may be obtained by Equation

$$cntsim ( U , C ) = \frac{{Σ}_{tag ∈ C} {max}_{ctx ∈ U} ( sim ( tag , ctx ) )}{N ( C )} ,$$

in the above Equation, U represents a set of nodes relevant to the context of the user, C represents a set of nodes relevant to the context of the contents, ctx represents a member of U, tag represents a member of C, and sim (tag, ctx) represents similarity between tag and ctx.

The similarity may be obtained by Equation sim(x,y)=spec(LCS(x,y)) when tax=x and ctx=y, in the above Equation, LCS (x, y) represents a least common subsumer between node x and node y.

According to still another exemplary embodiment of the present invention, there is provided a method for recommending contents using a hierarchical context model, including: receiving a keyword to be retrieved from a user according to an operation of a key or a menu; matching tag information of contents and context information of a user corresponding to the received keyword with preset hierarchical context models, respectively and extracting contents relevant words and context relevant words based on the matched result; calculating contents similarity based on the extracted contents relevant words and context relevant words and ranking at least one pre-collected contents based on the calculated contents similarity; and displaying some or all of the at least one ranked contents on a screen.

In the extracting, when the context information of the user is acquired, it may be confirmed whether the acquired context information of the user is updated and when the context information of the user is updated, the acquired context information of the user may map the hierarchical context model.

In the extracting, when the context information of the user is acquired, it may be confirmed whether the acquired context information of the user is updated and when the context information of the user is not updated, the acquired context information of the user may not map the hierarchical context model.

The contents similarity may be obtained by Equation

$$cntsim ( U , C ) = \frac{{Σ}_{tag ∈ C} {max}_{ctx ∈ U} ( sim ( tag , ctx ) )}{N ( C )} ,$$

in the above Equation, U represents a set of nodes relevant to the context of the user, C represents a set of nodes relevant to the context of the contents, ctx represents a member of U, tag represents a member of C, and sim (tag, ctx) represents similarity between tag and ctx.

The similarity may be obtained by Equation sim(x,y)=spec(LCS(x,y)) when tax=x and ctx=y, in the above Equation, LCS (x, y) represents a least common subsumer between node x and node y.

In the extracting, the tag information of the contents may match the preset hierarchical context model to extract contents relevant words based on the matched result and the contents relevant words may be extracted from a node corresponding to the tag information of the contents and all upper nodes connected to the node within the hierarchical context model.

In the extracting, the context information of the user may match the preset hierarchical context model to extract context relevant words based on the matched result and the context relevant words may be extracted from a node corresponding to the context information of the user and all upper nodes connected to the node within the hierarchical context model.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an apparatus for recommending contents according to an exemplary embodiment of the present invention;

FIGS. 2A and 2B are diagrams describing a context model according to an exemplary embodiment of the present invention;

FIG. 3 is a diagram illustrating a method for recommending contents according to an exemplary embodiment of the present invention;

FIG. 4 is a diagram describing a principle of calculating contents similarity according to an exemplary embodiment of the present invention;

FIGS. 5A to 5C are diagrams illustrating a screen displaying contents according to an exemplary embodiment of the present invention;

FIGS. 6A and 6B are diagrams illustrating an elapse time as an evaluation result according to an exemplary embodiment of the present invention; and

FIGS. 7A and 7B are diagrams illustrating an nDCG value as an evaluation result according to an exemplary embodiment of the present invention.

### DESCRIPTION OF THE PREFERRED EMBODIMENTS

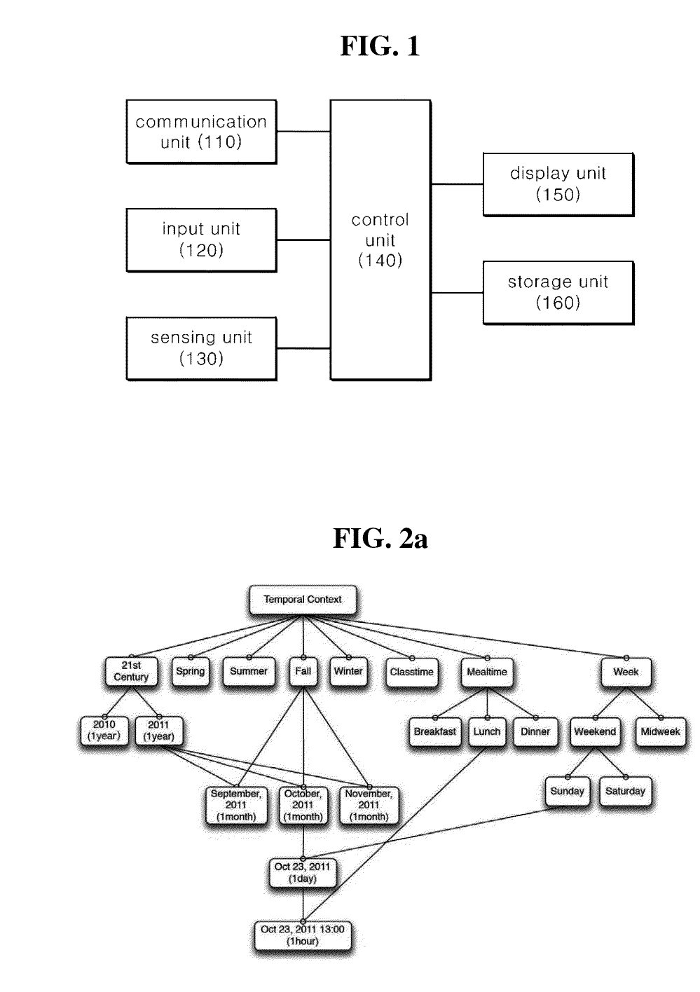

Hereinafter, an apparatus for recommending contents using a hierarchical context model and a method thereof according to the exemplary embodiment of the present invention will be described with reference to FIGS. 1 to 7B. Components required to understand an operation and an action according to the exemplary embodiment of the present invention will be mainly described in detail.

In addition, in describing components of the present invention, like components may be denoted by different reference numerals throughout the drawings and may also be denoted by like reference numerals despite different drawings. However, even in the above-mentioned case, the corresponding components mean having different functions according to exemplary embodiments or do not mean having the same functions in different exemplary embodiments and functions of each component are to be understood based on the description of each component in the corresponding exemplary embodiment.

In particular, the present invention provides a new contents recommending technique capable of collecting tag information of contents and context information of a user corresponding to a keyword received from a user, matching the tag information of the collected contents and the context information of the user with a preset hierarchical context model to extract contents relevant words and context relevant words based on the matched result, and ranking the contents based on similarity between the extracted contents relevant words and context relevant words.

FIG. 1 is a diagram illustrating an apparatus for recommending contents according to an exemplary embodiment of the present invention.

As illustrated in FIG. 1, the apparatus for recommending contents according to the exemplary embodiment of the present invention may be configured to include a communication unit 110, an input unit 120, a sensing unit 130, a control unit 140, a display unit 150, a storage unit 160, and the like. The device may be a concept covering a mobile phone, a smart phone, personal digital assistants (PDAs), a tablet PC (personal computer), a notebook, and the like.

The communication unit 110 may transmit and receive various information using wired communication or wireless communication.

The input unit 120 may receive a keyword to be retrieved from a user according to an operation of a key or a menu.

The sensing unit 130 may include at least one sensor, for example, a global positioning system (GPS), and the like which may acquire the context information of the user.

When receiving a keyword to be retrieved from the user, the control unit 140 may collect the tag information of the contents and the context information of the user corresponding to the received keyword.

The control unit 140 may match the tag information of the collected contents and the context information of the user with the preset hierarchical context models, respectively to be able to extract the contents relevant words and the context relevant words based on the matched result.

The control unit 140 may calculate the contents similarity based on the extracted contents relevant words and context relevant words and rank the pre-collected contents based on the calculated contents similarity.

In this case, the context information of the user may be acquired from sensors of a mobile device and the sensor, for example, the GPS calculates a latitude coordinate, a longitude coordinate, and a height coordinate.

The display unit 150 may display some or all of the plurality of ranked contents.

The storage unit 160 may store the hierarchical context model for recommending contents.

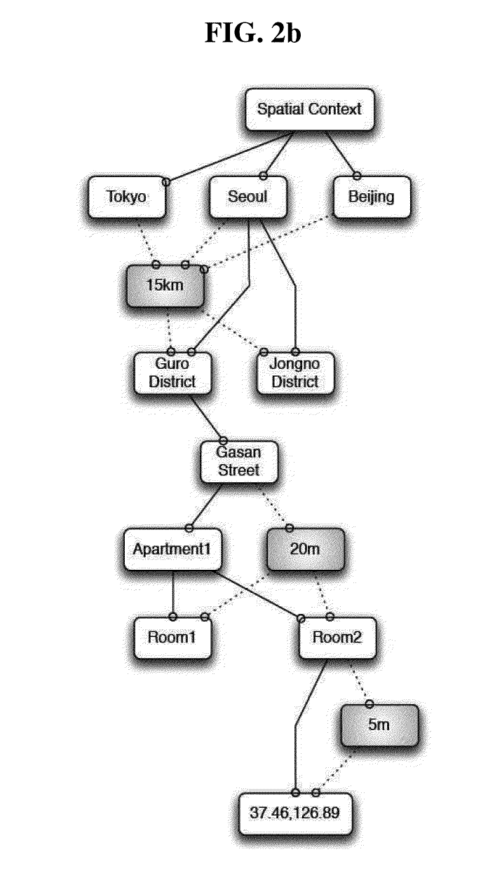

FIGS. 2A and 2B are diagrams describing a context model according to an exemplary embodiment of the present invention.

Referring to FIGS. 2A and 2B, the hierarchical context model according to the exemplary embodiment of the present invention may be implemented in a directed acyclic graph which represents time, space, general contents, or a matter of concern in terms of a partial order hierarchy.

For example, FIG. 2A represents the hierarchical context model which represents a temporal relationship and FIG. 2B represents the hierarchical context model which represents a spatial relationship.

The exemplary embodiment of the present invention adds the context of the user and tag representing attributes of contents as a node of a graph to implement the context model with a hierarchical graph storing the tag.

The directed acyclic graph G may be represented by the following [Equation 1].

G=(V,E) [Equation 1]

In the above Equation 1, V represents the node on the directed acyclic graph and E represents an edge.

An edge of a first graph within the directed acyclic graph represents a partial relationship. For example, referring to FIG. 2A, a time interval “Oct. 23, 2011 13:00” is a portion of “Oct. 23, 2011 afternoon” and as a result, is a portion of “Oct. 23, 2011”.

An edge of a second graph within the directed acyclic graph represents the same size or small relationship. For example, “Oct. 23, 2011” has a size of 24 h or 86,400 s.

Therefore, since interval A which is a portion of another interval B may not be larger than B, the graph representing the partial relationship becomes a sub-graph of the graph representing size information.

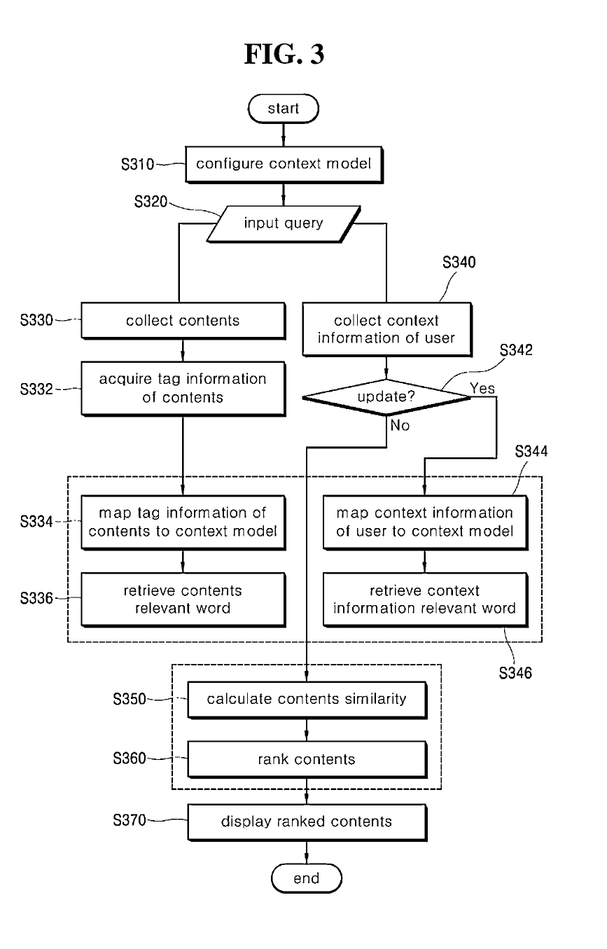

FIG. 3 is a diagram illustrating a method for recommending contents according to an exemplary embodiment of the present invention.

As illustrated in FIG. 3, the apparatus (hereinafter, referred to as contents recommending apparatus) for recommending contents according to the exemplary embodiment of the present invention may first configure the hierarchical context model (S310).

Next, the apparatus for recommending contents may receive a keyword to be retrieved from a user (S320).

Next, the apparatus for recommending contents may search at least one contents corresponding to the received keyword (S330) and collect the tag information included in at least one retrieved contents, respectively (S332).

Next, the apparatus for recommending contents may map the tag information of the collected contents with the hierarchical context model (S334) and extract the words relevant to the context information of the contents based on the mapped result (S336).

Similarly, the apparatus for recommending contents may collect the context information of the user (S340). In this case, the context information of the user may be acquired from the sensors of the mobile device.

Next, the apparatus for recommending contents may map the context information of the user with the hierarchical context model (S344) and extract the words relevant to the context of the user based on the mapped result (S346).

In other words, when the context information of the user maps the hierarchical context model, the context information of the user may belong to at least one node within the hierarchical context model based on a predefined rule. For example, referring to FIG. 2A, when the predefined rule is (‘Oct. 23, 2011, 13:00’⊂ ‘Oct. 23, 2011’) and (‘13:00’⊂ ‘Lunch time’), the context information of the user is ‘Oct. 23, 2011, 13:00’.

When the context information is specified, the corresponding context information belongs to a node which is positioned at a lower layer.

Therefore, the apparatus for recommending contents according to the exemplary embodiment of the present invention may extract words relevant to the context information of the user from an upper node which is directly or indirectly connected to the specific node.

The words relevant to the context information of the user are described herein but the same principle may also be applied to the case of extracting the words relevant to the tag information of the contents.

In this case, the apparatus for recommending contents confirms whether the collected context information of the user is updated (S342) and if it is confirmed that the collected context information of the user is updated, maps the collected context information of the user with the hierarchical context model.

On the other hand, the apparatus for recommending contents omits a process of mapping the context information of the user with the context model since the context information of the user is not changed if it is confirmed that the context information of the user is not updated.

Next, the apparatus for recommending contents may calculate contents similarity based on the words relevant to the extracted context information of the contents and the words relevant to the context of the user (S350).

The contents similarity cntsim (U, C) may be represented by the following [Equation 2].

$$cntsim ( U , C ) = \frac{{Σ}_{tag ∈ C} {max}_{ctx ∈ U} ( sim ( tag , ctx ) )}{N ( C )} , \qquad [ Equation 2 ]$$

In the above Equation 2, U represents a set of nodes relevant to the context of the user, C represents a set of nodes relevant to the context of the contents, ctx represents a member of U, and tag represents a member of C.

Further, sim (tag, ctx) represents similarity between tag and ctx and when generalizing the sim (tag, ctx) by representing tax by x and ctx by y, sim (x, y) is represented by the following [Equation 3].

sim(x,y)=spec(LCS(x,y)) [Equation 3]

In the above Equation 3, LCS (x, y) represents a least common subsumer between node x and node y.

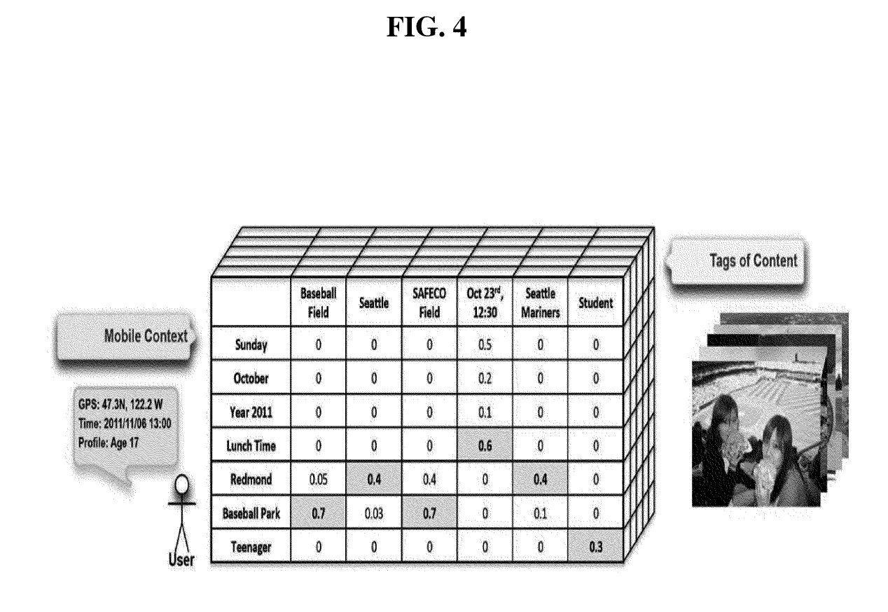

FIG. 4 is a diagram describing a principle of calculating contents similarity according to an exemplary embodiment of the present invention.

As illustrated in FIG. 4, similarity between words, Sunday, October, Year 2011, Lunch Time, Redmond, Baseball Park, Teenager which are relevant to the context of the user of a vertical column and words, Baseball Field, Seattle, SAFECO Field, October 23rd 12:30, Seattle Mariners, Student which are relevant to the context of the contents of a horizontal row is shown by a numerical value.

The contents similarity cntsim (U, C) using the similarity is represented by the following [Equation 4].

$$\begin{matrix}cntsim ( U , C ) = \frac{{Σ}_{tag ∈ C} {max}_{ctx ∈ U} ( sim ( tag , ctx ) )}{N ( C )} \\ = \frac{0.7 + 0.4 + 0.7 + 0.6 + 0.4 + 0.3}{6} \\ = 0.52\end{matrix} \qquad [ Equation 4 ]$$

Next, the apparatus for recommending contents may rank the contents retrieved based on the calculated contents similarity (S360) and display some or all of the contents depending on the ranked result (S370).

In this case, the apparatus for recommending contents may display some or all of the contents and may also display a portion of the applied hierarchical context model, the tag information of the retrieved contents, and the like.

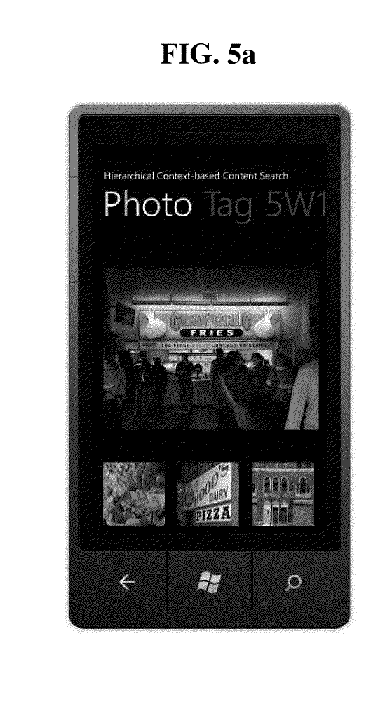

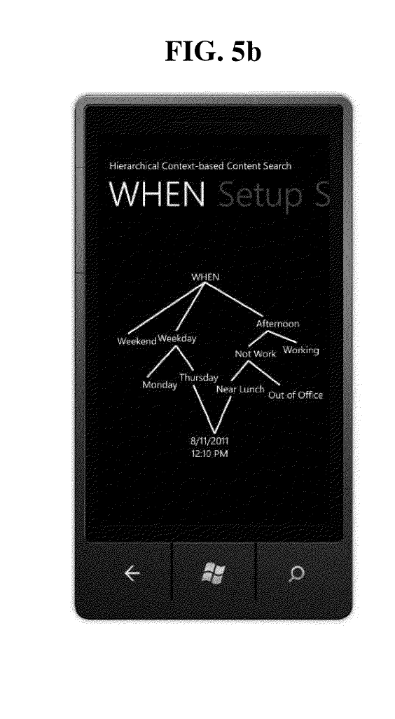

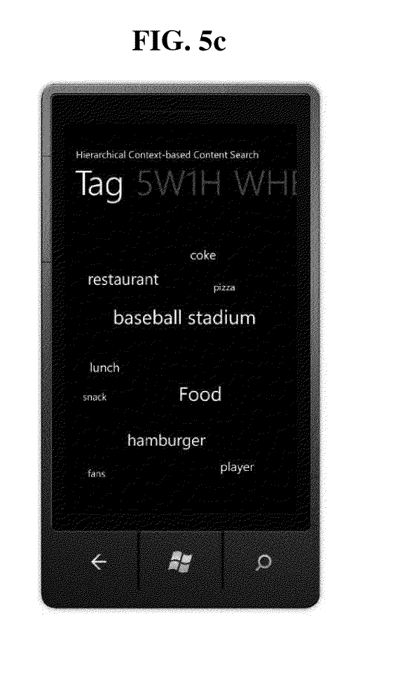

FIGS. 5A to 5C are diagrams illustrating a screen displaying contents according to an exemplary embodiment of the present invention.

As illustrated in FIGS. 5A to 5C, some of the retrieved photo contents, for example, photo contents having an upper ranking are displayed on a screen of the mobile device according to the exemplary embodiment of the present invention.

For example, referring to FIG. 5A, the photo contents having the highest ranking among the retrieved contents are displayed largest on the screen and the contents having the second highest ranking are displayed small on a lower end of the screen.

Further, the photo contents displayed on the screen may be enlarged largely by a touch of the user.

Further, the rest contents which are not displayed on the screen of the mobile device but have a low ranking may be displayed in the case in which the user scrolls the contents left and right or up and down.

FIG. 5B illustrates some of the hierarchical context models which are applied to the method for recommending contents according to the exemplary embodiment of the present invention, that is, a configuration of some of nodes or context knowledge nodes.

FIG. 5C illustrates some or all of the tag information of the contents retrieved according to the method for recommending contents according to the exemplary embodiment of the present invention, in which the tag information of the contents may be used as a query for searching for new contents.

Hereinafter, a result of simulating the performance of the method for recommending contents according to the exemplary embodiment of the present invention is illustrated.

The proposed method for recommending contents is compared with five methods for recommending contents. The five methods for recommending contents used as the comparison target are as follows.

1) A baseline algorithm A1-BASE uses the number of tags of contents matching a query instead of the context information of the user to determine a ranking of contents. 2) Algorithm A2-SPATI uses the context, that is, the spatial information without using the hierarchical context model. 3) Another algorithm A3-TEMPO uses the context temporal information without using the hierarchical context model. 4) Another algorithm A4-PERSO uses the context, that is, the personal information without using the hierarchical context model. 5) Algorithm A5-CONTE uses each content without using the hierarchical context model.

To evaluate the method for recommending contents, the same data are used and scored as follows to determine how much the photo is appropriate for an interest of a user.

1) When the photo is not generally relevant to a query, the score is 1, 2) when the photo is generally relevant to a query but deviates from the interest of a user, the score is 2, 3) when the photo is generally relevant to a query and is generally relevant to the interest of a user, the score is 3, 4) when the photo is relevant to a query and is generally relevant to the interest of a user, the score is 4, and 5) the photo is relevant to a query and is accurately relevant to the interest of a user, the score is 5.

Precision and recall for the algorithms are calculated based thereon. Here, the precision represents a ratio of the relevant photos among all the retrieved photos and the recall represents a ratio of the relevant photos among all the relevant photos, which are defined by the following [Equation 5] and [Equation 6].

$$\begin{matrix}precision = \frac{\vert \{ relevant photos \} ⋂ \{ retrieved photos \} \vert}{\vert \{ retrieved photos \} \vert} & [ Equation 5 ] \\ recall = \frac{\vert \{ relevant photos \} ⋂ \{ retrieved photos \} \vert}{\vert \{ relevant photos \} \vert} & [ Equation 6 ]\end{matrix}$$

When the precision and the recall are applied to algorithm different from the proposed inventions, they are as the following [Table 1].

TABLE 1

| | |
|---|---|
| R | R+ |

| Algorithm | precision | recall | precision | recall |
|---|---|---|---|---|
| A1-BASE | 48% | 29% | 31% | 21% |
| A2-SPATI | 59% | 38% | 39% | 29% |
| A3-TEMPO | 56% | 37% | 36% | 25% |
| A4-PERSO | 60% | 37% | 40% | 30% |
| A5-CONTE | 61% | 38% | 41% | 31% |
| PROPOSED | 70% | 46% | 49% | 35% |

In the above Table 1, R represents ‘Relevant’ and R+ represents “Very relevant”.

As a result of evaluating the precision and the recall and comparing the evaluated results, it may be appreciated that the method for recommending contents according to the exemplary embodiment of the present invention is more effective than other contents recommending algorithms.

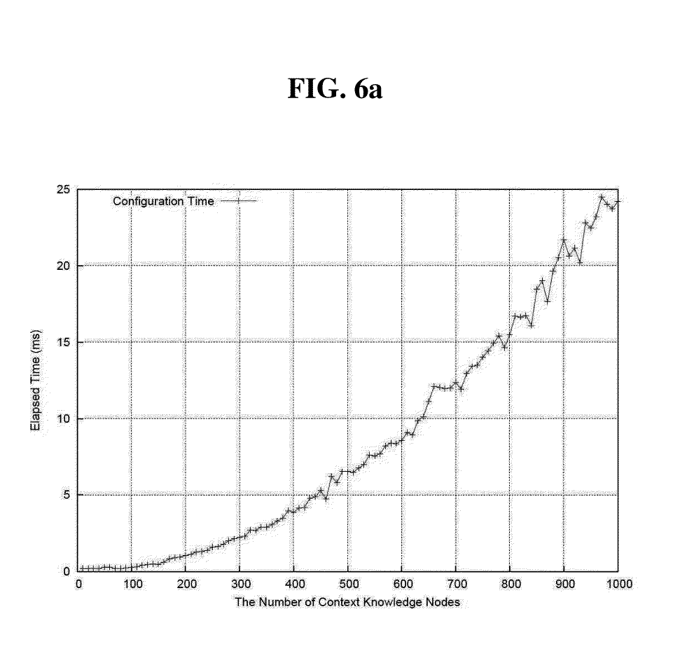

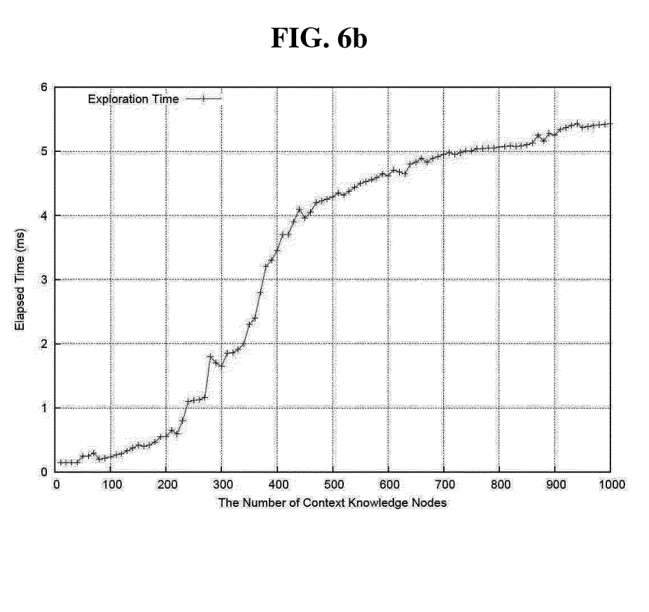

FIGS. 6A and 6B are diagrams illustrating an elapse time as an evaluation result according to an exemplary embodiment of the present invention.

As illustrated in FIGS. 6A and 6B, the hierarchical context model is configured as the evaluation results of the method for recommending contents according to the exemplary embodiment of the present invention and the elapsed time is shown.

For example, FIG. 6A illustrates the hierarchical context model configured at an initial stage of starting the algorithm and the elapsed time and FIG. 6B illustrates the elapsed time to retrieve relevant terms in the hierarchical context model for each query.

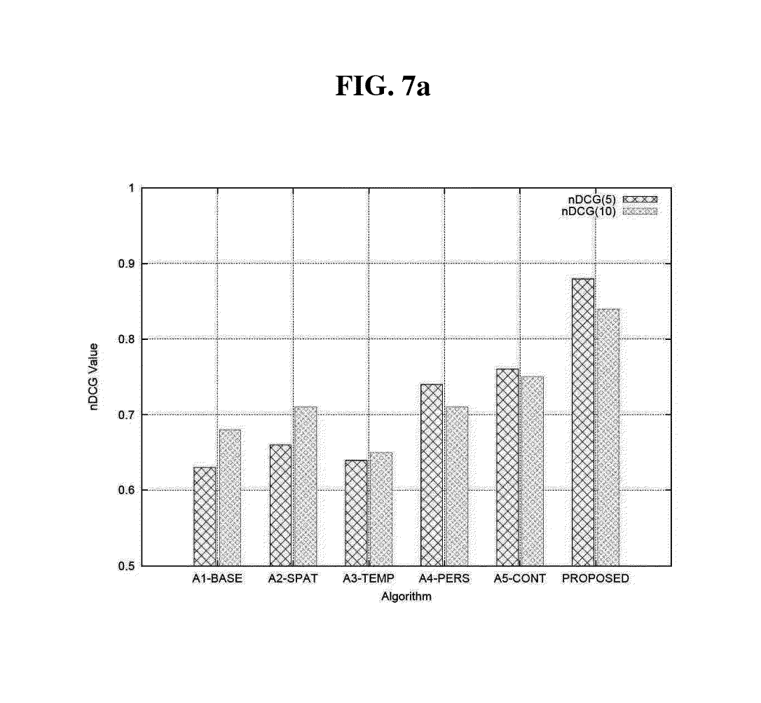

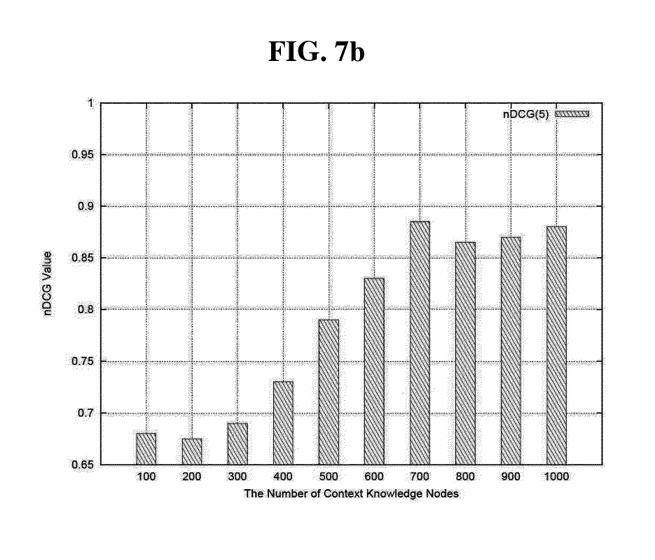

FIGS. 7A and 7B are diagrams illustrating an nDCG value as the evaluation result according to an exemplary embodiment of the present invention.

As illustrated in FIGS. 7A and 7B, the method for recommending contents according to the exemplary embodiment of the present invention shows normalized discounted cumulative gain (nDCG) values of the other contents recommending algorithm.

For example, FIG. 7A illustrates a result of comparing the nDCG values depending on the retrieval of 5 items and 10 items by different algorithms and FIG. 7B illustrates a result of comparing the nDCG values depending on the number of context knowledge nodes of the hierarchical context model.

Comparing with, for example, the elapsed time and the nDCG values as the evaluation results described with reference to FIGS. 6A to 7B, it may be appreciated that the algorithm according to the exemplary embodiment of the present invention is the most effective.

Meanwhile, the present invention describes that all the components configuring the embodiment of the present invention as described above are coupled in one or are operated, being coupled with each other, but is not necessarily limited thereto. That is, all the components may be operated, being optionally coupled with each other within the scope of the present invention. Further, all the components may be each implemented in one independent hardware, but a part or all of each component may be selectively combined to be implemented as a computer program having a program module performing some functions or all the functions combined in one or a plurality of hardwares. Further, the computer program is stored in computer readable media, such as a USB memory, a CD disk, a flash memory, and the like, to be read and executed by a computer, thereby implementing the exemplary embodiment of the present invention. An example of the storage media of the computer program may include a magnetic recording medium, an optical recording medium, a carrier wave medium, and the like.

As set forth above, according to the exemplary embodiments of the present invention, it is possible to effectively recommend the contents by collecting the tag information of the contents and the context information of the user corresponding to the keyword received from the user, matching the tag information of the collected contents and the context information of the user with the preset context model to extract the contents relevant words and the context relevant words based on the matched result, and ranking the contents based on the similarity between the extracted contents relevant words and context relevant words.

Further, according to the exemplary embodiments of the present invention, it is possible to improve the satisfaction of the user by recommending the contents required by the user using the preset context model.

A person with ordinary skilled in the art to which the present invention pertains may variously change and modify the foregoing exemplary embodiments without departing from the scope of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. An apparatus for recommending contents using a hierarchical context model, the apparatus comprising:
an input unit configured to receive a keyword to be retrieved from a user according to an operation of a key or a menu;
a sensing unit configured to acquire context information of the user when the keyword is received;
a control unit configured to match tag information of contents and the context information of the user corresponding to the received keyword with preset hierarchical context models, respectively to extract contents relevant words and context relevant words based on the matched results and calculate contents similarity based on the extracted contents relevant words and context relevant words to rank at least one pre-collected contents based on the calculated contents similarity; and
a display unit configured to display some or all of the at least one ranked contents on a screen.

2. The apparatus of claim 1, wherein the control unit confirms whether the acquired context information of the user is updated when the context information of the user is acquired, and
maps the acquired context information of the user to the hierarchical context model when the context information of the user is updated.

3. The apparatus of claim 2, wherein the control unit confirms whether the acquired context information of the user is updated when the context information of the user is acquired, and
does not map the acquired context information of the user to the hierarchical context model when the context information of the user is not updated.

4. The apparatus of claim 1, wherein the contents similarity is obtained by Equation
$$cntsim ( U , C ) = \frac{{Σ}_{tag ∈ C} {max}_{ctx ∈ U} ( sim ( tag , ctx ) )}{N ( C )} ,$$
in the above Equation, U represents a set of nodes relevant to the context of the user, C represents a set of nodes relevant to a context of contents, ctx represents a member of U, tag represents a member of C, and sim (tag, ctx) represents similarity between tag and ctx.

5. The apparatus of claim 4, wherein the similarity is obtained by Equation sim(x,y)=spec(LCS(x,y)) when tax=x and ctx=y,
in the above Equation, LCS (x, y) represents a least common subsumer between node x and node y.

6. The apparatus of claim 1, wherein the control unit matches the tag information of the contents with the preset hierarchical context model to extract contents relevant words based on the matched result, and
extracts the contents relevant words from a node corresponding to the tag information of the contents and all upper nodes connected to the node within the hierarchical context model.

7. The apparatus of claim 1, wherein the control unit matches the context information of the user with the preset hierarchical context model to extract context relevant words based on the matched result, and
extracts the context relevant words from a node corresponding to the context information of the user and all upper nodes connected to the node within the hierarchical context model.

8. The apparatus of claim 1, further comprising:
a storage unit configured to store the hierarchical context model for recommending contents to be retrieved by the user.

9. An apparatus for recommending contents using a hierarchical context model, the apparatus comprising:
an input unit configured to receive a keyword to be retrieved from a user according to an operation of a key or a menu;
a control unit configured to match tag information of contents and context information of a user corresponding to the received keyword with preset hierarchical context models, respectively to extract contents relevant words and context relevant words based on the matched results and calculate contents similarity based on the extracted contents relevant words and context relevant words to rank at least one pre-collected contents based on the calculated contents similarity; and
a display unit configured to display some or all of the at least one ranked contents on a screen.

10. The apparatus of claim 9, wherein the control unit confirms whether the acquired context information of the user is updated when the context information of the user is acquired, and
maps the acquired context information of the user to the hierarchical context model when the context information of the user is updated.

11. The apparatus of claim 10, wherein the control unit confirms whether the acquired context information of the user is updated when the context information of the user is acquired, and
does not map the acquired context information of the user to the hierarchical context model when the context information of the user is not updated.

12. The apparatus of claim 9, wherein the contents similarity is obtained by Equation
$$cntsim ( U , C ) = \frac{{Σ}_{tag ∈ C} {max}_{ctx ∈ U} ( sim ( tag , ctx ) )}{N ( C )} ,$$
in the above Equation, U represents a set of nodes relevant to the context of the user, C represents a set of nodes relevant to a context of contents, ctx represents a member of U, tag represents a member of C, and sim (tag, ctx) represents similarity between tag and ctx.

13. The apparatus of claim 12, wherein the similarity is obtained by Equation sim(x,y)=spec(LCS(x,y)) when tax=x and ctx=y,
in the above Equation, LCS (x, y) represents a least common subsumer between node x and node y.

14. A method for recommending contents using a hierarchical context model, the method comprising:
receiving a keyword to be retrieved from a user according to an operation of a key or a menu;
matching tag information of contents and context information of the user corresponding to the received keyword with preset hierarchical context models, respectively to extract contents relevant words and context relevant words based on the matched result;
calculating contents similarity based on the extracted contents relevant words and context relevant words and ranking at least one pre-collected contents based on the calculated contents similarity; and
displaying some or all of the at least one ranked contents on a screen.

15. The method of claim 14, wherein in the extracting, when the context information of the user is acquired, it is confirmed whether the acquired context information of the user is updated, and
when the context information of the user is updated, the acquired context information of the user maps the hierarchical context model.

16. The method of claim 15, wherein in the extracting, when the context information of the user is acquired, it is confirmed whether the acquired context information of the user is updated, and
when the context information of the user is not updated, the acquired context information of the user does not map the hierarchical context model.

17. The method of claim 14, wherein the contents similarity is obtained by Equation
$$cntsim ( U , C ) = \frac{{Σ}_{tag ∈ C} {max}_{ctx ∈ U} ( sim ( tag , ctx ) )}{N ( C )} ,$$
in the above Equation, U represents a set of nodes relevant to the context of the user, C represents a set of nodes relevant to a context of contents, ctx represents a member of U, tag represents a member of C, and sim (tag, ctx) represents similarity between tag and ctx.

18. The method of claim 17, wherein the similarity is obtained by Equation sim(x,y)=spec(LCS(x,y)) when tax=x and ctx=y,
in the above Equation, LCS (x, y) represents a least common subsumer between node x and node y.

19. The method of claim 14, wherein in the extracting, the tag information of the contents matches the preset hierarchical context model to extract contents relevant words based on the matched result, and
the contents relevant words are extracted from a node corresponding to the tag information of the contents and all upper nodes connected to the node within the hierarchical context model.

20. The method of claim 14, wherein in the extracting, the context information of the user matches the preset hierarchical context model to extract context relevant words based on the matched result, and
the context relevant words are extracted from a node corresponding to the context information of the user and all upper nodes connected to the node within the hierarchical context model.
